(19) United States
(12) Patent Application Publication
(10) Pub. No.: US 2021/0158840 A1
(43) Pub. Date: May 27, 2021

(54) MAGNETIC TAPE HEAD WITH SOFT BIAS

(71) Applicant: International Business Machines Corporation, Armonk, NY (US)

(72) Inventors: David Seagle, Morgan Hill, CA (US); Robert Biskeborn, Hollister, CA (US); Robert Fontana, San Jose, CA (US); Icko E. T. Iben, Santa Clara, CA (US)

(21) Appl. No.: 16/694,829

(22) Filed: Nov. 25, 2019

(51) Int. Cl. G11B 5/39

(52) U.S. Cl. CPC G11B 5/3932; G11B 5/3912

(57) ABSTRACT

An approach to forming a tape head with a first soft bias pinning layer in a tape head structure. The tape head structure includes an antiferromagnetic material forming the first soft bias pinning layer over a sensor and stitching into a soft bias layer surrounding the sensor where the antiferromagnetic material of the first soft bias pinning layer has a lower magnetic reluctance than a material forming a freelayer in the sensor. Furthermore, the tape head structure includes a first spacer separated from the first soft bias pinning layer by the sensor in the tape head structure and a second spacer layer over the first soft bias pinning layer where a thickness of the first spacer and the second spacer is determined by an optimum shield to shield distance in the tape head structure.

### BACKGROUND OF THE INVENTION

The present invention relates generally to the field of magnetic storage device technology, and more particularly to magnetic read and write heads for tape drive storage using soft bias.

Computer systems rely heavily on the use of data storage technology, such as, magnetic hard disk drives (HDD) which typically includes a rotating magnetic disk and tape drives utilizing a magnetic tape medium for data storage. Initially, tape drives using magnetic tape for data storage were developed for computer data storage. More recently, HDD heads reading high density tracks in very thin rotating disks have become a preferred method of data storage for computer systems.

Disk technology for HDD heads provide much higher density tracks, very thin media for the magnetic disks, and ultra-smooth surfaces for disk drive operation. HDD heads designed to read high linear density tracks on the thin media work in close proximity to the magnetic disks. In the last decade, improvements to HDD heads include incorporation of soft bias technology to provide side shielding of adjacent tracks, a larger available bias field due to a higher magnetic remanence, and a more uniform bias across a large number of heads in a disk drive. In order to effectively operate, a shield to shield spacing surrounding a sensor within the HDD head must be sufficiently small to differentiate or capture individual magnetic flux transitions within the magnetic disk. Spacing between the HDD head and the magnetic disk can commonly be in the two nanometer range.

In comparison, tape heads read lower linear density tracks in a tape media, which is a much thicker medium that does not provide as smooth or even surface as a magnetic disk. Because tape heads read lower linear density tracks on a thicker media (e.g., a magnetic tape) with a much less even surface then a disk, the gap or space between the tape head and magnetic tape can be ten times greater than a gap required between a HDD head and a magnetic disk. The read gap space between the tape head and the tape must be much larger to identify the flux from a magnetic transition in the tape to read recorded data on the tape. While the gap for HDD head to disk is in the two nanometer range, the gap from the tape head to magnetic tape is commonly in the fifteen to thirty nanometer range.

### SUMMARY

Embodiments of the present invention provide a first soft bias pinning layer in a first tape head structure. The tape head structure includes a ferromagnetic material forming the first soft bias pinning layer abutting and stitching into a soft bias layer surrounding a sensor where the ferromagnetic material of the first soft bias pinning layer has a lower magnetic reluctance than a material forming a freelayer in the sensor. The tape head structure includes a first spacer separated from the first soft bias pinning layer by the sensor in the tape head structure and a second spacer layer over the first soft bias pinning layer where a thickness of the first spacer and the second spacer is determined by an optimum shield to shield distance in the tape head structure.

A second soft bias pinning layer in a second tape head structure is provided. The second tape head structure includes a ferromagnetic material over an enhanced stitching layer forming a second soft bias pinning layer stitching, where the ferromagnetic material stitches into the enhanced stitching layer and the enhanced stitching layer stitches into a soft bias layer. The second tape head structure includes a first spacer separated from a first soft bias pinning layer by a sensor in the tape head structure and a second spacer layer over the first soft bias pinning layer, wherein a thickness of the first spacer and the second spacer is determined by an optimum shield to shield distance in the tape head structure.

### BRIEF DESCRIPTION OF THE DRAWINGS

FIG. 1A depicts a portion of a first tape head surface facing the magnetic tape for a first tape head structure using a modified soft bias technology, in accordance with an embodiment of the present invention.

FIG. 1B depicts a cross-section through the middle of the portion of the tape head in FIG. 2A and includes a gap between the tape head with the modified soft bias structure and a portion of magnetic tape, in accordance with an embodiment of the present invention.

FIG. 2 depicts a portion of a second tape head surface facing the magnetic tape for a second tape head structure using a modified soft bias technology, in accordance with an embodiment of the present invention.

FIG. 3 depicts a portion of a third tape head surface facing the magnetic tape for a third tape head structure using a modified soft bias technology, in accordance with an embodiment of the present invention.

FIG. 4 depicts a portion of a fourth tape head surface facing the magnetic tape for a fourth tape head structure using a modified soft bias technology, in accordance with an embodiment of the present invention.

### DETAILED DESCRIPTION

Embodiments of the present invention recognize that tape head technology reading low linear density magnetic tape utilizes conventional hard bias technology for tape head design and manufacture. Embodiments of the present invention recognize that the use of soft bias technology in tape heads would provide side shielding of adjacent tracks, larger available bias field due to a higher remanence provided by soft bias technology, and an ability to provide more uniform bias across a large population or a large number of tape heads in a tape drive. Embodiments of the present invention recognize that soft bias technology, as currently designed for HDD heads, will not function in tape heads because the stabilization magnetics will shunt a significant amount of the transition flux away from the freelayer in the tape head, leaving insufficient signal or transition flux for the tape head to accurately read recorded data. Embodiments of the present invention recognize developing an effective way to apply soft bias technology to tape head design that provides reliable data retrieval from low density tape with adequate stabilization magnetics to identify required magnetic flux transitions would improve tape head functionality.

Embodiments of the present invention provide a method to integrate soft bias technology in tape head design and manufacture. Embodiments of the present invention provides a method to modify soft bias technology, as used in HDD heads, to reliably read flux transitions to retrieve data from magnetic tape. Embodiments of the present invention provide a new structure for tape heads that integrates soft bias technology using new tape head structures including at least one of a direct pinning structure, a simple pinned structure, a simple pinned structure with a cobalt or cobalt/iron stitching layer, a simple pinned structure with cobalt (Co) or cobalt/iron (CoFe) stitching to antiferromagnet that is over a NiFe layer stitching to NiFe in the soft bias layer, and a synthetic pinned structure with the antiferromagnet stitched to NiFe and the NiFe stitching to soft bias (NiFe). Embodiments of the present invention provide a tape head utilizing soft bias technology in order to provide better side shielding of adjacent tracks in the tape, a larger available bias field due to a higher magnetic remanence using soft bias technology, and a more uniform bias across a group of tape heads in the tape drive. Additionally, embodiments of the present invention will provide tape head structures utilizing soft bias technology by incorporating a soft bias pinning layer that stabilizes the soft bias at the edges of tape tracks without shunting the magnetic flux away from the freelayer and allowing the freelayer to properly read the flux transition (e.g., data) within the tape.

Detailed embodiments of the claimed structures and methods are disclosed herein. The method steps described below do not form a complete process flow for manufacturing integrated circuits, such as, magnetic tape heads for tape drives. The present embodiments can be practiced in conjunction with the integrated circuit fabrication techniques currently used in the art, for magnetic tape heads, and only so much of the commonly practiced process steps are included as are necessary for an understanding of the described embodiments. The figures represent cross-section portions of a magnetic tape head and/or magnetic tape after fabrication and are not drawn to scale, but instead are drawn to illustrate the features of the described embodiments. Specific structural and functional details disclosed herein are not to be interpreted as limiting, but merely as a representative basis for teaching one skilled in the art to variously employ the methods and structures of the present disclosure. In the description, details of well-known features and techniques may be omitted to avoid unnecessarily obscuring the presented embodiments.

References in the specification to “one embodiment”, “other embodiment”, “another embodiment”, “an embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure, or characteristic is described in connection with an embodiment, it is understood that it is within the knowledge of one skilled in the art to affect such feature, structure or characteristic in connection with other embodiments whether or not explicitly described.

For purposes of the description hereinafter, the terms “upper”, “lower”, “right”, “left”, “vertical”, “horizontal”, “top”, “bottom”, and derivatives thereof shall relate to the disclosed structures and methods, as oriented in the drawing figures. The terms “overlying”, “atop”, “over”, “on”, “positioned on” or “positioned atop” mean that a first element is present on a second element wherein intervening elements, such as an interface structure, may be present between the first element and the second element. The term “direct contact” means that a first element and a second element are connected without any intermediary conducting, insulating or semiconductor layers at the interface of the two elements.

In the interest of not obscuring the presentation of the embodiments of the present invention, in the following detailed description, some of the processing steps or operations that are known in the art may have been combined together for presentation and for illustration purposes and in some instances may not have been described in detail. In other instances, some processing steps or operations that are known may not be described. It should be understood that the following description is focused on the distinctive features or elements of the various embodiments of the present invention.

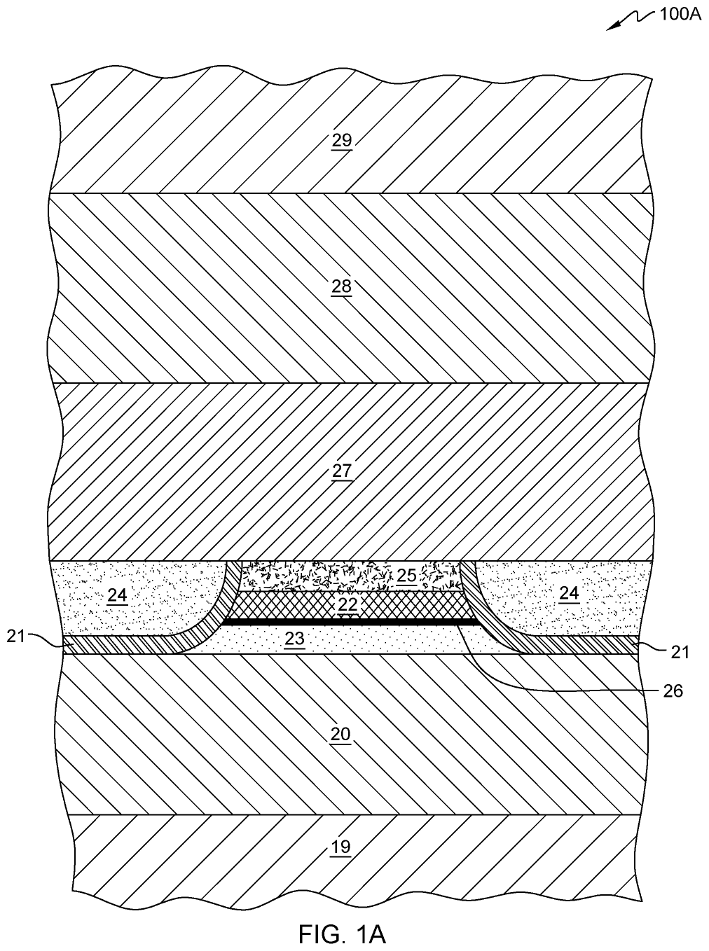

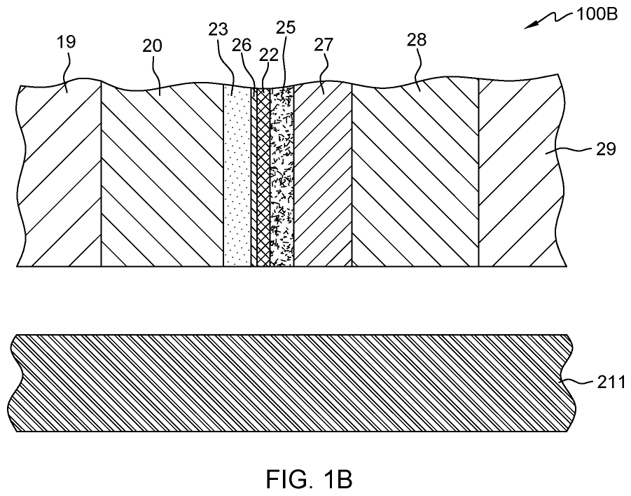

FIG. 1A depicts a portion of a surface of tape head 100A facing the magnetic tape (not depicted) for a first tape head structure using soft bias technology, in accordance with an embodiment of the present invention. The portion of a surface of tape head 100A facing the magnetic tape (not depicted) as illustrated is in the vicinity of a sensor in the first tape head structure. As depicted, FIG. 1A includes first shield 19, first spacer 20, isolation layer 21, reference 23, barrier 26, freelayer 22, cap 25, soft bias 24, soft bias pinning layer 27, second spacer 28, and second shield 29 where reference 23, barrier 26, freelayer 22, and cap 25 comprise a sensor in tape head 100A. The structure of tape head 100A can be known as a direct pinning structure where the soft bias pinning layer 27 has infinite magnetic reluctance. In various embodiments, soft bias pinning layer 27 with a net magnetic moment of zero and a set direction of a magnetic flux stitches into soft bias 24, but does not stitch to freelayer 22 within the sensor composed of reference 23, barrier 26, freelayer 22, and cap 25. The head in a tape drive incorporates soft bias technology through the addition of soft bias 24 and soft bias pinning layer 27. In various embodiments, tape head 100A is a readback head using soft bias technology. In various embodiments, tape head 100A had a tape head structure that provides stabilization magnetics that maintain a sufficient signal from magnetic transition flux in the tape to reliably read data stored in the magnetic tape (e.g., tape head 100A provides a tape head structure that does not shunt away most of the transition flux).

As depicted in FIG. 1A, reference 23 resides between first spacer 20 and barrier 26 and is a portion of the sensor in tape head 100A. In various embodiments, although depicted as a single layer in FIGS. 1A, 1B, 3, 4, and 5, reference 23 is a plurality of layers of materials commonly used in tape head manufacture. In various embodiments, reference 23 is composed of a seed layer, an antiferromagnet, and a synthetic pinned layer. For example, the seed layer may be ruthenium (Ru), the antiferromagnet can be iridium manganese (IrMn) and the synthetic pinned layer can be CoFe/NiFe/CoFe/Ru/CoFe/NiFe/CoFe where Co is cobalt, Fe is iron and Ni is nickel. In some embodiments, reference 23 is composed of an antiferromagnet using a different antiferromagnet material commonly used in tape head manufacture. Similarly, in some embodiments, the synthetic pinned layer is composed of the same materials layered in a different order, composed of two or more of the same materials, or composed of one or more other magnetic materials commonly used as a part of a set of layers or reference layers. A typical thickness of reference 23 may be in the range of 10 to 20 nm.

In various embodiments, barrier 26 is a very thin layer between reference 23 and freelayer 22 that allows electrical detection of the angle of the magnetic field between reference 23 and freelayer 22. For example, barrier 26 may be a layer of magnesium oxide (MgO) with a thickness in the range of 0.5 to 2.0 nanometers. Barrier 26 is not limited to MgO but, may be any material used as a barrier in tape head manufacture. Barrier 26 is also a portion of the sensor in tape head 100A.

Freelayer 22 resides between barrier 26 and cap 25 and is a portion of the sensor in tape head 100A. In various embodiments, freelayer 22 is a magnetic material where the magnetic moment of freelayer 22 rotates when a magnet (e.g., a magnetic field) passes underneath freelayer 22. For example, freelayer 22 can detect a magnetic transition flux that occurs when a magnetic direction is changed in a magnetic tape under tape head 100A. When the magnetization or magnetic direction in the tape changes from left to right to right to left, this change creates a small area of a transition flux that can be detected by freelayer 22. In response to detecting a change in a magnetic field in a magnetic tape under freelayer 22, the magnetic moment of freelayer 22 rotates into or out of the plane of the diagram while the pinned reference layer 23 remains undisturbed. In an embodiment, freelayer 22 is composed of one of cobalt/iron, nickel/iron or a combination of these materials. Freelayer 22 can be composed of any material used for a freelayer in tape head manufacture.

Cap 25 resides between freelayer 22 and soft bias pinning layer 27 and cap 25 is also a portion of the sensor in tape head 100A. In various embodiments, cap 25 is used as a spacer between soft bias pinning layer 27 and freelayer 22. Cap 25 can be composed of any non-magnetic, conducting material commonly used in tape head manufacture, such as tantalum, ruthenium, or the like.

Isolation layer 21 surrounds the left and right sides of the sensor in tape head 100A (i.e., surrounds the side edges of reference 23, barrier 26, freelayer 22, and cap 25 of the sensor) and separates soft bias 24 from the sensor and from first spacer 20. In various embodiments, isolation layer 21 is an electrical isolation layer composed of a dielectric material, for example, Al2 O3. In some embodiments, isolation layer 21 is in the range of 3 to 20 nanometers thick. For example, isolation layer 21 can be 8 nanometers thick. Isolation layer 21 is not limited to Al2 O3 can be any dielectric material commonly used in tape or HDD head manufacture. Deposition of isolation layer 21 can be done using a typical tape head deposition process and may occur after one of a selective etch of reference 23, barrier 26, freelayer 22, and cap 25, or after a selective deposition of reference 23, barrier 26, freelayer 22, and cap 25 on first spacer 20.

Two sections of soft bias 24 reside under soft bias pinning layer 27 and over isolation layer 21 on either side of the sensor in tape head 100A (i.e., the sensor composed of reference 23, barrier 26, freelayer 22, and cap 25). In various embodiments, soft bias 24 abuts isolation layer 21 (i.e., is in direct contact with isolation layer 21) and soft bias pinning layer 27. In various embodiments, soft bias 24 can be composed of a soft magnetic material, for example, NiFe. Soft bias 24 may be 80/20 NiFe (80% Ni and 20% Fe) but is not limited to NiFe. For example, soft bias 24 is composed of NiFe, CoFe, or a combination of these materials (e.g., CoNiFe). As depicted in FIG. 1A, a thickness of soft bias 24 ranges between five and fifteen nm but, is not limited to these thicknesses.

Each of soft bias 24 can act as side shields for freelayer 22 when soft bias pinning layer 27 pins soft bias 24. In various embodiments, an addition of both soft bias 24 and soft bias pinning layer 27 provides soft bias technology to tape head 100A in a tape drive.

In various embodiments, soft bias pinning layer 27 is an antiferromagnet below spacer 28 and above soft bias 24 and cap 25. Soft bias pinning layer 27 can be composed of a laminate of materials with a magnetic permeance that is zero or nearly zero. Soft bias pinning layer 27 can stitch ferromagnetically into each of the two sections of soft bias 24 without stitching into freelayer 22. A set direction of the magnetization in soft bias pinning layer 27, such as, a left to right direction, can be forced into soft bias 24 (i.e., the set magnetic direction of soft bias pinning layer 27 sets a magnetic direction in each of soft bias 24 residing under soft bias pinning layer 27).

In various embodiments, soft bias pinning layer 27 is composed of three to twelve nanometer layer of iridium manganese (e.g., IrMn). For example, a thickness of soft bias pinning layer 27 can be at least six nanometers thick to provide adequate stability with tape head 100A. Soft bias pinning layer 27 is not limited to IrMn but, may be any non-magnetic material used in tape head manufacture.

As previously discussed, soft bias pinning layer 27 stitches ferromagnetically to each of soft bias 24 on either side of freelayer 22 to stabilize each of soft bias 24 that act as side shields. For a design of tape head 100A, it is important that soft bias pinning layer 27 has a higher reluctance (e.g., magnetic reluctance) than the reluctance of freelayer 22. Because reluctance is inversely related to permeability and thickness, a relationship can be developed where Ts multiplied by μs is greater than T F multiplied by μF. Using this relationship (e.g., Ts×μs<T F×μF) can aid in a design of tape head 100A using soft bias technology where, Ts is the thickness of the soft bias pinning layer (e.g., soft bias pinning layer 27); μs is the magnetic permeability of the soft bias pinning layer (e.g., soft bias pinning layer 27); TF is the thickness of the freelayer (e.g., freelayer 22); and , μF is the magnetic permeability of the freelayer (e.g., freelayer 22). When this relationship is met in the design of a tape head using soft bias technology, and when shield 29 is separated from soft bias pinning layer 27 by a non-magnetic material, (e.g., spacer 28), with a thickness determined to achieve an optimal shield to shield distance, then a tape head can reliably and effectively identify a flux transition area in the tape. This technique discussed above for evaluating materials and material thickness associated with a soft bias pinning layer in a tape head design applies to any tape head design, including tape head 100A, in addition to tape heads 200, 300, and 400 discussed later.

In various embodiments, second spacer 28 is a layer of a non-magnetic conductive material separating soft bias pinning layer 27 from second shield 29. For example, spacer 28 can be composed of iridium (Jr) or chrome. Second spacer 28 may be composed of any non-magnetic, electrically conductive material used in tape head manufacture. In various embodiments, a thickness of second spacer 28 is determined, based at least in part, on an optimum shield to shield distance as required for reliable detection within freelayer 22 of a magnetic flux transition in the tape under tape head 100A.

In various embodiments, a typical thickness of second spacer 28 in tape head 100A is greater than 20 nm. For example, a typical range of thickness for the second spacer 28 is in the range of 25 to 40 nm. In various embodiments, first spacer 20 has a similar thickness (e.g., greater than 20 nm and commonly, in the range of 25 to 40 nm thick). A thickness of second spacer 28 and first spacer 20 can be determined in order to provide an optimal shield to shield thickness. Once the optimal shield to shield distance is determined, a thickness of each of reference 23, barrier 26, freelayer 22, and cap 25 (i.e., the sensor) are added together and the sum subtracted from the optimum shield to shield distance to determine a spacer thickness. The resulting distance is divided between the two spacers as a spacer thickness in order to approximately position the freelayer between the two shields. In FIG. 1A, the optimum shield to shield distance would be the total thickness (i.e., the sum) of the thickness of the sensor, the thickness of the first spacer 20, the thickness of soft bias pinning layer 27, and the thickness of second spacer 28. More generally, an optimum shield to shield distance includes a determined thickness of a leading shield (e.g., first shield 19) and a trailing shield (e.g., second shield 29), a thickness of the sensor, and a thickness of any other layers (e.g., soft bias pinning layer 27 or other similar layers used for pinning soft bias 24) between the sensor and second spacer 28.

A shield to shield distance would be a distance between first shield 19 and second shield 29. A typical shield to shield distance would be in the 80 to 120 nm range for tape head 100A using soft bias technology, although the shield to shield distance can be larger. As known to one skilled in the art, a number of conventional equations for determining an optimal shield to shield distance may be applied to determine the optimal shield to shield distance. An optimal shield to shield distance may be determined for a drive density to provide an optimum read back signal for the target linear density tape drive. For example, adding together the thickness of reference 23, barrier 26, freelayer 22, cap 25, and soft bias pinning layer 27 results in about 40 nm and the optimum shield to shield distance is about 100 nm, then subtracting 40 nm from 100 nm results in 60 nm required for the two spacers. Therefore, first spacer 20 and second spacer 28 may have a thickness of approximately, 30 nm (e.g., 60 nm space needed for optimum shield to shield distance divided by two spacers). In various embodiments, a thickness of each of first spacer 20 and second spacer 28 is in the range of the range of twenty to forty nm.

In various embodiments, first spacer 20 and second spacer 28 are composed of a same material with a same material thickness. First spacer 20 may be a non-magnetic, electrically conductive material, such as, iridium (Jr) or chrome. First spacer 20 is not limited to Jr and chrome but, may be composed of any spacer material used in tape head manufacture. A thickness of first spacer 20 may be in the range of twenty to forty nm. A thickness of first spacer 20 may be determined as discussed above with reference to second spacer 28. In some embodiments, first spacer 20 and second spacer 28 are composed of two different materials.

First shield 19 resides under first spacer 20 and second shield 29 resides over second spacer 28. In various embodiments, first shield 19 and second shield 29 are each a soft magnetic material, such as, nickel/iron. First shield 19 and second shield 29 can be any commonly used soft magnetic material in tape heads (e.g., 80/20 nickel/iron). In various embodiments, a distance between first shield 19 and second shield 29 is determined to provide an optimum design for a shield to shield distance for tape head 100A using one of an accepted magnetic tape head design shield to shield evaluation methods or programs, as discussed in detail above with reference to second spacer 28. For example, an optimum shield to shield distance between first shield 19 and second shield 29 is in the range of 60 to 120 nanometers (e.g., 80 nm).

In summary, tape head 100A can effectively incorporate soft bias technology for use in a tape drive when the following conditions are met: (1) when a soft bias pinning layer, such as, soft bias pinning layer 27, stitches ferromagnetically to soft bias 24 to stabilize soft bias 24 as side shield (e.g., shielding freelayer 22 in the sensor); (2) when soft bias pinning layer 27 has a higher reluctance than freelayer 22 (e.g., which occurs when Ts×μs<TF×μF as discussed previously); and (3) first shield 19 is separated from second shield 29 with an optimal shield to shield distance and when soft bias pinning layer 27 is separated from second shield 29 by second spacer 28 where the thickness of second spacer 28 is determined using the determined spacer thickness for first spacer 20 and second spacer 28 that achieves the optimal shield to shield spacing for tape head 100A. The conditions 1-3 above can be used to incorporate soft bias technology in other tape head designs, such as, tape head 200, 300 and 400 discussed later.

FIG. 1B depicts a cross-section through the middle of the portion of the tape head 100A in FIG. 1A, a gap between tape head 100B and the magnetic portion of a cross-section of tape 211, in accordance with an embodiment of the present invention. As depicted, FIG. 1B includes first shield 19, first spacer 20, freelayer 22, reference 23, barrier 26, cap 25, soft bias pinning layer 27, second spacer 28, second shield 29, and tape 211 where a gap is depicted between tape 211 and tape head 100B. Note isolation layer 21 and soft bias 24 are not visible in FIG. 1B. In various embodiments, a gap between tape head 100B and tape 211 is in the range of fifteen to thirty nanometers.

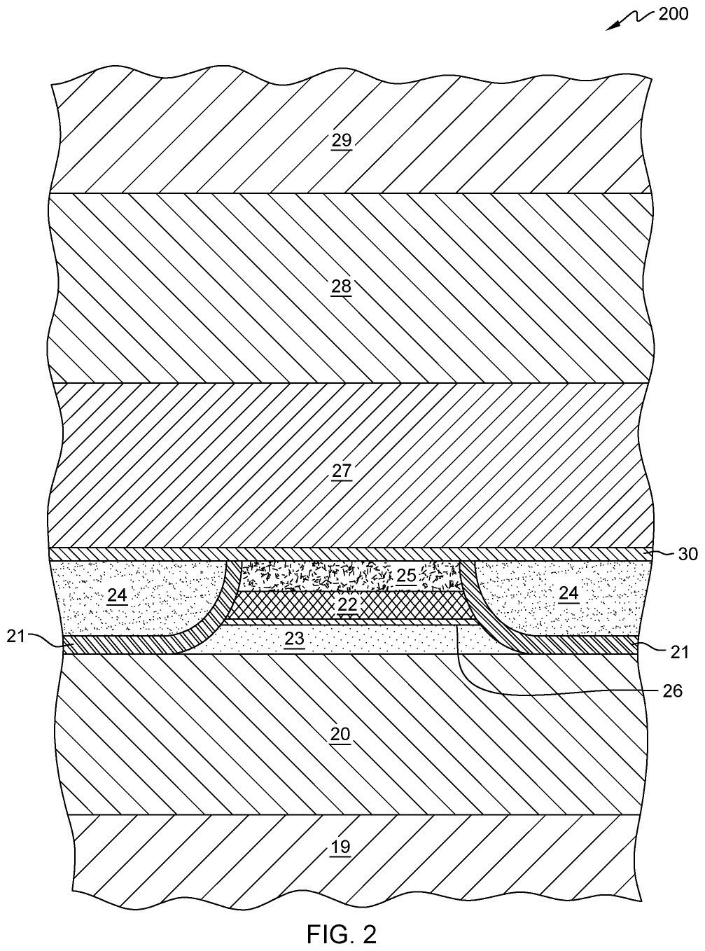

FIG. 2 depicts the portion of tape head 200 with a surface facing the magnetic tape (not depicted) for a second tape head structure using soft bias technology, in accordance with an embodiment of the present invention. As depicted, FIG. 2 includes all of the elements of FIG. 1A with the addition of stitching enhancement layer 30. FIG. 2 includes first shield 19, first spacer 20, isolation layer 21, barrier 26, freelayer 22, reference 23, soft bias 24, cap 25, soft bias pinning layer 27, second spacer 28, second shield 29, and stitching enhancement layer 30. The structure illustrated in tape head 200 can be a simple pinning structure with a cobalt or cobalt iron stitching layer. Because antiferromagnetic coupling of NiFe, in soft bias 24 to soft bias pinning layer 27, is not as good as the coupling of cobalt or cobalt in a cobalt iron (e.g., CoFe) to soft bias pinning layer 27, adding stitching enhancement layer 30 composed of cobalt or a cobalt compound material (e.g., CoFe) is done in tape head 200. In various embodiments, tape head 200 includes 0.5 to 5 nm of one of cobalt (e.g., Co) or CoFe for stitching enhancement layer 30. The addition of stitching enhancement layer 30 can improve coupling of the antiferromagnet (e.g., soft bias pinning layer 27) to soft bias 24. For example, coupling of the antiferromagnet in soft bias pinning layer 27, composed of IrMn, is very good to CoFe of stitching enhancement layer 30. The coupling for soft bias pinning layer 27 to cobalt in stitching enhancement layer 30 may be ten times better than the coupling of IrMn in soft bias pinning layer 27 to 80/20 NiFe in soft bias 24.

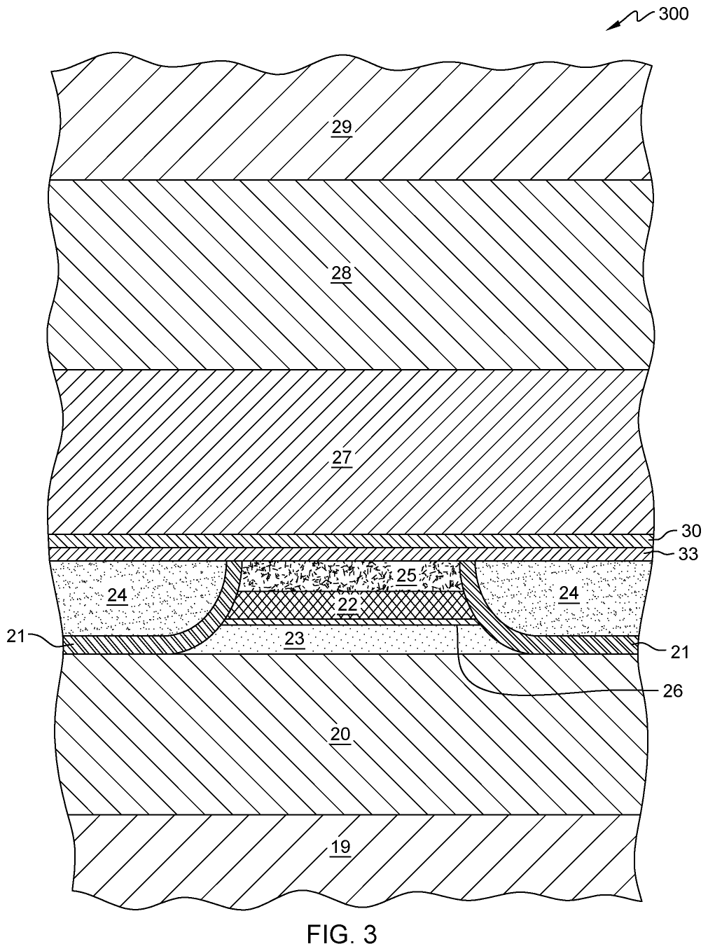

FIG. 3 depicts a portion of tape head 300 facing the magnetic tape (not depicted) for a third tape head structure using soft bias technology, in accordance with an embodiment of the present invention. As depicted, FIG. 3 includes all of the elements of FIG. 2 with the addition of soft magnet layer 33. FIG. 3 includes first shield 19, first spacer 20, isolation layer 21, freelayer 22, barrier 26, cap 25, soft bias 24, reference 23, soft bias pinning layer 27, spacer 28, second shield 29, stitching enhancement layer 30, and soft magnet layer 33. The structure of tape head 300 can be a simple pinned structure with Co or CoFe stitching to an antiferromagnetic layer (e.g., soft bias pinning layer 27) and NiFe to NiFe stitching of soft magnet layer 33 to soft bias 24.

In various embodiments, a very thin layer of soft magnet layer 33 is deposited over a top surface of each of soft bias 24, a portion of isolation layer 21, and cap 25. Stitching enhancement layer 30 can be deposited over soft magnet layer 33. In an embodiment, a thickness of soft magnet layer 33 is less than one half to five nanometers. In various embodiments, a thickness of stitching enhancement layer 30 is in a range of one half to five nm. For example, soft magnet layer 33 may be 1.5 nanometers thick and a thickness of stitching enhancement layer 30 may also be 1.5 nanometers. NiFe in soft magnet layer 33 stitches very well into the NiFe in soft bias 24.

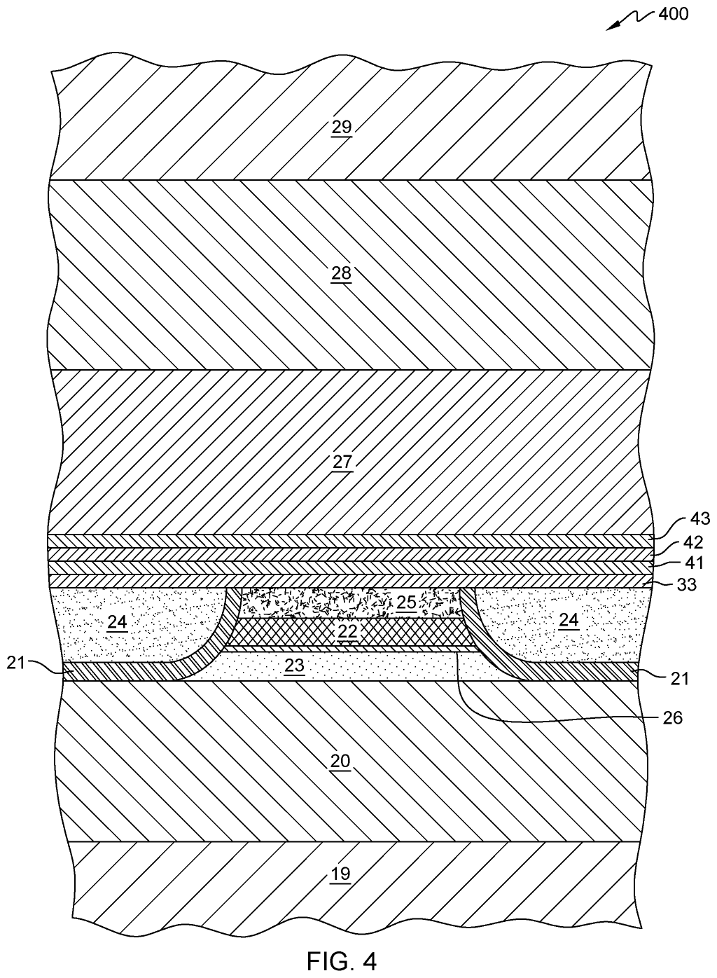

FIG. 4 depicts a portion of tape head 400 facing the magnetic tape (not depicted) for a fourth tape head structure using soft bias technology, in accordance with an embodiment of the present invention. As depicted, FIG. 4 includes all of the elements of FIG. 3 except that stitching enhancement layer 30 is replaced with a layer of a synthetic antiferromagnet. FIG. 4 includes first shield 19, first spacer 20, isolation layer 21, freelayer 22, cap 25, soft bias 24, reference 23, barrier 26, soft bias pinning layer 27, spacer 28, second shield 29, soft magnet layer 33 and layers 41, 42, and 43, where layer 43 is under soft bias pinning layer 27, layer 41 is over soft magnet layer 33, and layer 42 is between layers 41 and 43. The structure of tape head 400 can be a synthetic pinned structure where an antiferromagnet (e.g., soft bias pinning layer 27), which may be composed of, for example, IrMn, stitches to the cobalt or the cobalt in CoFe of a synthetic antiferromagnet (e.g., layers 41 and 43).

In various embodiments, the synthetic antiferromagnet is composed of very thin layers of a material, such as, ruthenium (Ru) surrounded on top and underneath by layers of cobalt or cobalt iron. The very thin layer of Ru, depicted as layer 42, can be in the range of 0.5 to 1.5 nm and each of the layers of Co or CoFe can have a thickness in the range of 0.5 to 1.5 nm, although in some cases the range may be larger (e.g., in old versions of tape drives). The synthetic antiferromagnet is composed of very thin layers of a material, such as, ruthenium (Ru) surrounded on top and underneath by layers of cobalt or cobalt nickel iron and provides a structure with an antiferromagnetic field that is close to the Ruderman-Kittel-Kasuya-Yosida (RKKY) antiferromagnetic coupling peak. Design of such a composite synthetic antiferromagnet is understood by one skilled in the art. It is deposited on a layer of one to ten nanometers of cobalt or cobalt nickel iron, depicted as layer 41 and another layer of one to ten nanometers of cobalt or cobalt iron, depicted as layer 43 is deposited over layer 42 to complete the synthetic magnet in tape head 400. For example, each of layers 41, 42, and 43 forming a synthetic antiferromagnet may be one nanometer thick. The synthetic antiferromagnet is not limited to CoFe and Ru but, may be any materials used in a synthetic antiferromagnet in a tape drive.

The synthetic antiferromagnet stitches to the soft NiFe magnet created in soft magnet layer 33. Soft magnet layer 33, in turn, stitches easily into each of soft bias 24, also composed of NiFe. As previously mentioned, with regard to FIG. 1A, none of soft bias pinning layer 27, synthetic antiferromagnet (e.g., composed of layers 41, 42, and 43), or soft magnet layer 33 stitch into freelayer 22. This is also true for tape head 200 and tape head 300 (e.g., that neither of stitching enhancement layer 30 or soft magnet layer 33 stitch into freelayer 22).

The result is a tape head as a bare die or in a packaged form that can be integrated into a tape drive. In any case, the tape head can be integrated with other tape heads, discreet circuit elements, a flex cable, a printed circuit card, a tape drive, or an end product, such as, a computing device. The end product can be any product that includes tape heads ranging from low-end applications to advanced computer and storage systems.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A tape head structure, comprising:
an antiferromagnetic material forming a soft bias pinning layer over a sensor and over a soft bias layer surrounding the sensor, wherein the antiferromagnetic material of the soft bias pinning layer has a lower magnetic reluctance than a material forming a freelayer in the sensor; and
a first spacer separating the soft bias pinning layer from a first shield and a second spacer over a second shield, wherein a thickness of each of the first spacer and the second spacer is determined by an optimum shield to shield distance in the tape head structure.

2. The tape head structure of claim 1, wherein the soft bias pinning layer stitches into the soft bias layer surrounding-the sensor to stabilize the soft bias layer as side shields, and wherein the soft bias layer is separated from the sensor by an isolation layer.

3. The tape head structure of claim 1, wherein a set direction of a magnetization in the soft bias pinning layer sets a magnetic direction in the soft bias layer.

4. (canceled)

5. The tape head structure of claim 1, wherein a total of a thickness of the soft bias pinning layer, a thickness of the sensor in the tape head structure, a thickness of the first spacer, and a thickness of the second spacer is the optimum shield to shield distance in the tape head structure.

6. The tape head structure of claim 5, wherein the sensor in the tape head structure includes a barrier layer over a reference layer, the freelayer over the barrier layer, and a cap layer over the freelayer.

7. The tape head structure of claim 1, wherein the soft bias pinning layer is an antiferromagnetic material.

8. The tape head structure of claim 1, wherein the soft bias pinning layer is iridium manganese.

9. The tape head structure of claim 1, wherein a thickness for each of the first spacer and the second spacer is in a range of twenty-five to forty nanometers.

10. The tape head structure of claim 1, wherein the soft bias pinning layer does not stitch into the freelayer in the tape head structure.

11. The tape head structure of claim 1, wherein the soft bias pinning layer is at least six nanometers thick.

12. The tape head structure of claim 1, wherein a thickness of the soft bias pinning layer, a thickness of a sensor in the first tape head structure, and the thickness of each of the first spacer and the second spacer provides the optimum shield to shield distance that allows the freelayer in the tape head structure to detect a magnetic flux transition in a magnetic tape under the sensor in the tape head structure.

13. The tape head structure of claim 1, wherein the soft bias layer is in two sections on either side of the sensor and each section of the soft bias layer is separated from the sensor by an isolation layer composed of a dielectric material.

14. The tape head structure of claim 1, wherein the soft bias pinning layer and the soft bias layer provide a soft bias technology to the tape head structure.

15. The tape head structure of claim 1, wherein the first spacer and the second spacer are composed of a same non-magnetic material with a same thickness.

16. The tape head structure of claim 1, wherein the optimum shield to shield distance between the first shield and the second shield is in a range of sixty to one hundred and twenty nanometers.

17. The tape head structure of claim 1, wherein the soft bias pinning layer stitches into the soft bias layer to stabilize each section of the soft bias layer on either side of the sensor, and wherein the soft bias pinning layer is separated from the first shield by the second spacer where the thickness of the first spacer is determined using a same determined spacer thickness for the first spacer and the second spacer that achieves the optimal shield to shield spacing for the tape head structure.

18. The tape head structure of claim 1, wherein the antiferromagnetic material forming the soft bias pinning layer meets a relationship where a thickness of the antiferromagnetic-material of the soft bias pinning layer multiplied by a magnetic permeability of the antiferromagnetic material forming the soft bias pinning layer is less than a thickness of the freelayer multiplied by the magnetic permeability of the freelayer.

19. The tape head structure of claim 1, wherein the second spacer over the second shield is under a portion of the isolation layer separating the soft bias layer from the sensor and is under the sensor.
